(19) United States
(12) Patent Application Publication
(10) Pub. No.: US 2017/0027223 A1
(43) Pub. Date: Feb. 2, 2017

(54) Vaporizer With Multiple-Chamber Heating

(71) Applicant: Vahan Eksouzian, Glendale, CA (US)

(72) Inventor: Vahan Eksouzian, Glendale, CA (US)

(73) Assignee: Cloud V Enterprises, Glendale, CA (US)

(21) Appl. No.: 14/813,112

(22) Filed: Jul. 29, 2015

(51) Int. Cl. A24F 47/00; H05B 3/44; H05B 1/02

(52) U.S. Cl. CPC A24F 47/008; H05B 1/0297; H05B 3/44

(57) ABSTRACT

A vaporizer comprising a mouthpiece and battery. The mouthpiece preferably includes a loading chamber, a funnel disposed directly below the loading chamber, and an atomizer disposes directly below the funnel. The atomizer includes a heat source connected to the battery for vaporizing a substance desired to be inhaled. The loading chamber and funnel are each connected to heating elements, electrically connected to the battery, for heating a substance located in the loading chamber or funnel, respectively. An air pathway is provided within the mouthpiece that allows a user to inhale a substance vaporized in the atomizer after it travels through the loading chamber and funnel.

### BACKGROUND OF THE INVENTION

1. Field of the Invention

The present invention relates generally to the field of vaporizers used to heat solids, liquids and suspensions, such as waxes and oils, for inhalation by a user.

2. Prior Art

Vaporizers, including electronic cigarettes, have become increasingly popular over the past ten years. As consumers have become more aware of the health consequences of inhaling smoke produced by combusting tobacco and other substances, vaporizers have become a healthier alternative to cigarettes, cigars, pipes and other smoking implements. While some vaporizers are large and bulky—sometimes intended to mimic the aesthetic look of a hookah—most vaporizers are small enough to fit into a user's pocket or purse for convenience.

The typical configuration of a compact vaporizer includes a battery electrically connected to an atomizer housed within the vaporizer. The solid, liquid or suspension material sought to be vaporized is placed in the atomizer, or alternatively placed in a separate housing connected to the atomizer by a wick. The atomizer includes one or more heating coils electrically connected to a battery. When activated, the heating coil heats the substance in contact with the heating coil and vaporizes that substance so that the user may inhale the resulting vapor.

While a wick may be suitable to control the flow of a low viscosity liquid material, such as e-juice, to the heating coil of an atomizer, a wick is not capable of transporting a higher viscosity fluid or suspension, like wax or oil, to the heating coil. Moreover, a wick does not enable a user to selectively control the flow of the material to the heating coil.

There exists a need for a compact vaporizer that provides the user with the ability to control the volume of the substance to be vaporized, and cleanly and efficiently directs the substance sought to be vaporized toward a heating coil to minimize the proportion of the substance left unvaporized. The present invention, the preferred embodiment of which is desired herein, meets this need, and further provides an atomizer that conveniently and reliably engages and disengages the vaporizer, and ensures no degradation or chemical reaction between the atomizer and the loaded substance.

### SUMMARY OF THE INVENTION.

The present invention, or more accurately the preferred embodiment of the present invention, provides a compact vaporizer comprising a multiple-chamber atomizer that allows a user to control the volume of a substance to be vaporized, and ensures contact between a heating coil and all of the substance loaded into the atomizer by the user. The atomizer comprises an upper chamber and a lower chamber disposed below the upper chamber. At the bottom of the upper chamber, a funnel directs the substance to the lower chamber, and specifically to the heating coil disposed within the lower chamber. The substance is controllable heated when in the upper chamber by one or more heating elements disposed on the outside of the upper chamber, so as to reduce the viscosity of the substance. The diameter of the funnel opening is such that high viscosity liquids and suspensions, such as oil and wax, only pass through the funnel to the lower chamber when they are heated. In this manner, the volume of the substance passing to the heating coil in the lower chamber can be controlled by the user.

The atomizer is easily and conveniently attached to, and detached from, the vaporizer housing unit. When the atomizer is attached to the vaporizer housing unit, it is also in electrical contact with the battery. The atomizer includes at least one heating coil, and the inside wall of the atomizer—both the upper and lower chambers—is shaped so as to cause a liquid or suspension, such as wax, oil or e-juice, to be directed toward contact with, or close proximity to, the heating coil. The heating coil, or alternatively a small heating dish, is likewise positioned in the atomizer to heat, and thus vaporize, the loaded liquid or suspension, particularly the portion of the loaded liquid or suspension that is in contact with, or close proximity to, the heating coil. Preferably, the inside wall of the atomizer is constructed from a material that will not degrade from heat at temperatures up to at least 400 degrees Fahrenheit, and will not degrade or otherwise react chemically with substances commonly vaporized, including wax, oil, and e-juice.

### BRIEF DESCRIPTION OF THE DRAWINGS

FIG. 1 is a perspective view of a compact vaporizer consistent with the preferred embodiment of the present invention.

FIG. 2 is a perspective view of a compact vaporizer consistent with the preferred embodiment of the present invention, with certain components thereof detached from one another.

FIG. 3 is a schematic view of the mouthpiece of a compact vaporizer consistent with the preferred embodiment of the present invention.

FIG. 4 is a schematic cross-sectional view of a compact vaporizer consistent with the preferred embodiment of the present invention.

### DETAILED DESCRIPTION OF THE PREFERRED EMBODIMENT OF THE INVENTION

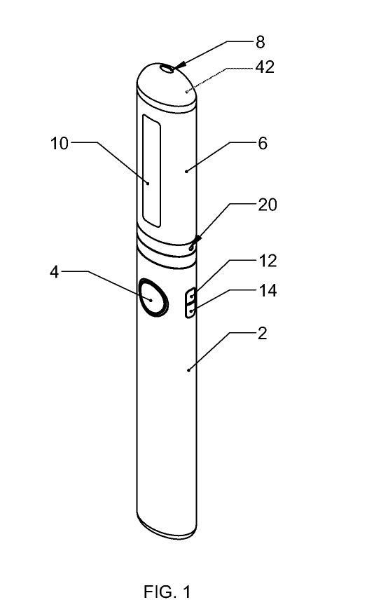

As depicted in FIG. 1, the preferred embodiment compact vaporizer includes a battery housed within a battery casing 2 and a mouthpiece 6. Disposed on the battery casing is a large button 4 that enables a user to activate a heating coil (discussed below). Two additional buttons, the tank heater button 12 and funnel heater button 14, are also disposed on the battery casing 2. As discussed more fully below, activation of the tank heater button 12 heats the outside of the tank where material is loaded into the compact vaporizer, and activation of the funnel heater button 14 heats the outside of the funnel disposed immediately below the tank where material is loaded.

The mouthpiece 6 has a clear window 10 that allows the user to view the inner workings of the components within the mouthpiece 6. Through the window 10, the user can see how much of the substance to be vaporized remains in the tank, and, preferably, also how much of the substance to be vaporized is in the funnel.

Disposed at the top of the mouthpiece 6 is an inhalation opening 8. Through the inhalation opening 8, the user can inhale the substance vaporized through the operation of the compact vaporizer as described herein. An airway opening 20 is provided near the bottom of the mouthpiece 6. The airway opening 20 is a small hole that allows air to enter the mouthpiece 6, particularly when a user is inhaling through the inhalation opening 8. Because the mouthpiece 6 is tightly sealed to the battery casing 2 during operation, the airway opening 20 is necessary to provide for air circulation through the mouthpiece 6 when a user is inhaling through inhalation opening 8.

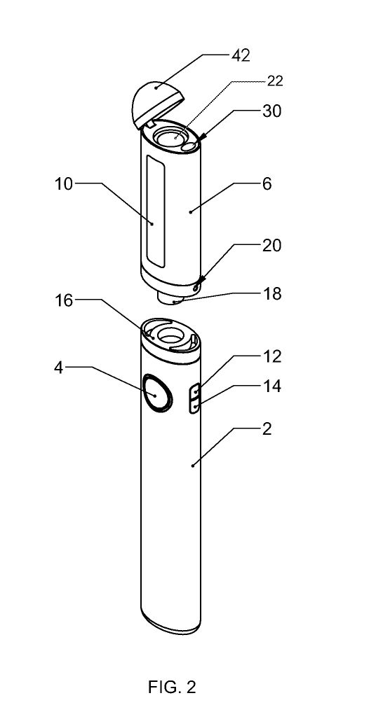

Turning to FIG. 2, the mouthpiece 6 of the preferred embodiment is separable from the battery casing 2 to allow for replacement of the components within the battery casing 2 or the mouthpiece 6 without replacing the entire compact vaporizer. The respective shapes of battery connector 16, disposed at the top of battery casing 2, and mouthpiece connector 18, disposed at the bottom of the mouthpiece 6, are configured to provide for a secure connection between when the mouthpiece 6 is turned clockwise approximately 30 degrees. When the battery casing 2 and mouthpiece 6 are physically connected to one another by means of batter connector 16 and mouthpiece connector 18, an electrical connection between the battery and the components within the mouthpiece 6 is also established, as more fully discussed below. Those skilled in the art will recognize that there are a number of different mechanisms and configurations that enable a suitable removable connection between mouthpiece 6 and battery casing 2.

Mouthpiece 6 includes a window 10, through which the components inside the mouthpiece 6 are visible. The window 10 enables the user to view the vapor created within the mouthpiece 6, as well as the loading chamber 22, funnel 24 and atomizer 26, the operation of which are all discussed more fully below. Specifically, through window 10 the user can monitor the progress of the loaded substance traveling from the funnel 24 to the atomizer 26.

Disposed at the top of mouthpiece 6 is the mouthpiece lid 42. Mouthpiece lid 42 is rotatably connected to the rest of mouthpiece 6 by means of a pin, hinge or other suitable connection mechanism that allow mouthpiece lid to swing open to reveal loading chamber 22 and airway opening 30. Opening the mouthpiece lid 42 enables the user to load a desired substance into loading chamber 22. Loading chamber 22 includes a gasket that enables a secure seal closing off loading chamber 22 when mouthpiece lid 42 is in the closed position for use. In contrast, an air pathway between airway opening 30 and inhalation opening 8 is maintained when mouthpiece lid 42 is in the closed position.

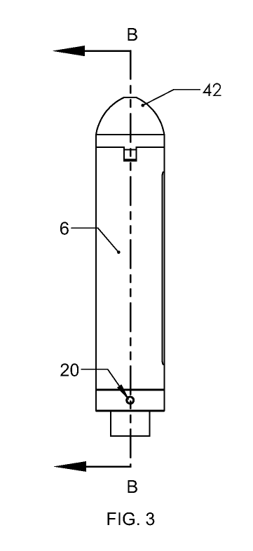

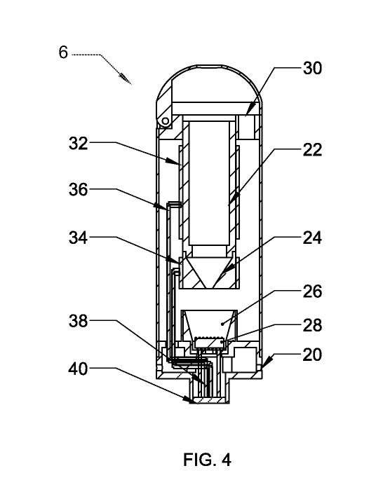

Turning to FIG. 3, a side view of the mouthpiece 6 of the preferred embodiment is shown. FIG. 4 provides a schematic cross-sectional view of the mouthpiece 6 and the components therein, taken along line B-B, depicted in FIG. 3. The inner workings of the mouthpiece 6 of the preferred embodiment of the present invention can best be understood with reference to FIG. 4.

Turning specifically to FIG. 4, the connection port 40 is disposed at the bottom of mouthpiece 6. Connection port 40 facilitates electrical connection between components in the mouthpiece 6, on the one hand, and components in or on the battery casing 2, such as the battery, tank heater button 12 and funnel heater button 14. The connection port 40 includes at least two wires that supply electrical power to a heating coil 28 in an atomizer 26. Additional wires 38 within the connection port 40 provide electrical power to one or more heating elements disposed on the outside of loading chamber 22 and funnel 24.

The connection port 40 may also optionally provide for electrical communication between sensors disposed within the mouthpiece 6 and a controller housed within the battery casing 2. For example, it may be desirable to adjust the electrical power to the heating coil 28, loading chamber heating element 32, or funnel heating element 34, based on the temperature in the loading chamber 22, funnel 24 or atomizer 26, and/or the volume of the substance loaded by a user that is located in the loading chamber 22, funnel 24 or atomizer 26 at a particular time. Through the operation of volume and temperature sensors, electrically connected to a controller, the operation of the vaporizer of the preferred embodiment may be optimized.

The operation of the vaporizer of the preferred embodiment is best understood by an illustration of its use starting with a user loading a high viscosity substance, such as a wax or oil, into the loading chamber 22, and ending with the user inhaling the vapor of that substance through inhalation opening 8. After loading the substance into loading chamber 22, the user closes mouthpiece lid 42, preventing any airflow between inhalation opening 8 and loading chamber 22. At room temperature, the high viscosity substance is likely to stick to the outer wall of loading chamber 22, and not travel down to the bottom of loading chamber 22 with any significant speed. By activating the tank heater button 12, the loading chamber heating element 32 is provided electrical power, and thus emits heat. The loading chamber heating element 32 is in close proximity, and preferably physically connected, to the loading chamber 22. Both the loading chamber heating element 32 and the outer wall of the loading chamber 22 are made of one or more materials that are good conductors of heat so as to permit the heat generated by the loading chamber heating element 32 to be transmitted to the outer wall of the loading chamber 22. Heating the outer wall of loading chamber 22 causes the temperature in the loading chamber 22 to increase, and specifically heats the high viscosity substance placed in the loading chamber 22 by the user. The amount of heat created by the loading chamber heating element 32 should be either pre-selected, based on the particular substance, or controlled to provide for a temperature only high enough to sufficiently reduce the viscosity of the substance loaded in the loading chamber 22 to facilitate the substance traveling down the loading chamber 22. Through the heating of the substance, and gravity, the substance travels from the loading chamber 22 to the funnel 24.

When the substance arrives in the funnel 24 from the loading chamber 22, it cools such that the viscosity increases, unless of course the funnel 24 is similarly heated as the loading chamber 24. The opening at the bottom of the funnel 24 is sized so as to prevent a high viscosity substance, such as wax or oil, from exiting the funnel 24, and to allow only a slow and steady flow of the substance to exit the funnel 24 when it is heated. Considering the substance(s) most often desired to be vaporized by users, the funnel opening at the bottom of the funnel is preferably around 2 millimeters in diameter, and the substance is heated to approximately 150 to 160 degrees Fahrenheit to pass through the funnel opening. In this manner, by providing separately controllable heating elements for heating the loading chamber 22 and funnel 24, respectively, the preferred embodiment allows a user to cause a substance to travel from the loading chamber 22 to the funnel 24 and then remain in the funnel 24 until the user desires to vaporize the substance.

When the substance in the funnel 24 is heated so as to cause it to exit the funnel 24, it is directed, by means of the funnel opening disposed at the bottom of the funnel 24, to drip down to the atomizer 26, and specifically to the heating coil 28. In this manner, the substance can be vaporized at a steady and controllable rate, rather than having too much or too little of the substance vaporized at any particular time. That in turn allows the user to know and control how much of the substance is to be vaporized in any given inhalation.

The heating coil 28 heats the substance to a temperature sufficient to vaporize the substance, but not so high as to combust the substance. The atomizer 26 of the preferred embodiment may be any suitable material capable of withstanding heat and repeated changes in temperature, but is preferably metallic or ceramic. The horizontal cross section of the atomizer 26 is preferably circular or oval in shape, and, if oval, the longest diameter of the oval cross section coinciding with the length of the heating coil 28, in order to maximize contact or proximity of the substance with the heating coil 28. The atomizer 26 is tapered, such that the circumference of the oval cross section is less at the elevation of the heating coil 28 that at the top of the atomizer 26. The atomizer 26 is preferably made of a material that is a good conductor of heat, will not react chemically with substances commonly used in vaporizers, and can withstand high and repeatedly changing temperatures, such as ceramic. Optionally, a wick is disposed inside of the heating coil 28 to absorb the substance to be vaporized and bring it into close proximity of the heating coil 28. Those skilled in the art will understand that the wick may be a fiber wick, a ceramic rod, or some other material suitable for withstanding temperatures of at least 500 degrees Fahrenheit.

Those skilled in the art will recognize that this configuration between the loading chamber 22, funnel 24 and atomizer 26 provides for several advantages. Among those advantages, the configuration of the preferred embodiment of the present invention facilitates easy loading at a location separated from the heating coil to avoid any damage to the heating coil 28 caused by loading the substance directly into the atomizer 26. The configuration of the preferred embodiment, particularly the location and size of the funnel opening relative to the heating coil 28, also directs all of the substance to the heating coil 28. This is in stark contrast to the conventional vaporizer configuration, which includes a cylindrical atomizer with a circular cross section which the user loads directly, resulting in a sudden rush of vaporized substance, and accumulation of unvaporized material in the portions of the atomizer that are too distant from the heating coil. Through the configuration shown in FIG. 4, a substance placed anywhere in the loading chamber 22 is caused to travel to the heating coil 28 where it is vaporized such that it may be inhaled by a user. Further, the substance is pre-heated before it reaches the heating coil 28, and thus is vaporized with less time in contact with the heating coil 28, which also facilitates control of the rate at which the substance is vaporized.

The top of atomizer 26 is open, such that the vaporized substance, after being heated by heating coil 28, emanates from the atomizer 26 to fill empty areas of the mouthpiece 6. An air pathway is maintained between airway opening 30 and the top of atomizer 26. Thus, by providing suction on the inhalation opening 8, a user can inhale the vapor created by the heating coil 28. Those skilled in the art will recognize that it may be desirable to provide an insulating material in various parts of the mouthpiece 6 to prevent the outside of mouthpiece 65 from becoming too hot from activation of the heating coil 28, loading chamber heating element 32 and funnel heating element 34, and to keep the heat from said heating coil 28 and heating elements 32 and 34 from unintentionally impacting other components. However, any such insulation must not interfere with the air pathway connecting airway opening 20, atomizer 26, airway opening 30 and inhalation opening 8.

While FIG. 4 depict an atomizer 26 with a heating coil 28 wrapped around a wick, it should be recognized that it may be advantageous to eliminated the wick. It may also be advantageous to replace the heating coil 28 and wick with a heated pan at the bottom of the atomizer 26. The heated pan may consist of any heat-conductive material(s), but preferably is ceramic where the pan comes into contact with the substance to be vaporized. This configuration provides even greater interchangeability of substances because, unlike with a porous wick with which a small quantity of the substance would remain and be vaporized in a subsequent use, there is no absorption of any substance in a ceramic pan.

It is understood that many modifications and variations may be devised given the above description of the principles of the invention and a preferred embodiment of the invention. It is intended that all such modifications and variations be considered within the spirit and scope of this invention, as defined by the following claims.

The invention claimed is:

1. A vaporizer comprising:
and electrical source; and
a mouthpiece, comprising:
an atomizer electrically connectable with said electrical source and comprising a heat source; and
a funnel positioned directly above said atomizer so as to direct a substance placed in said funnel into said atomizer.

2. The vaporizer of claim 1 wherein said funnel comprises a first heating element electrically connected to said electrical source.

3. The vaporizer of claim 2, wherein electrical power from said electrical source to said first heating element is initiated by a user pressing a button.

4. The vaporizer of claim 2 further comprising a sensor positioned in said funnel and electrically connected to a controller capable of adjusting electrical power provided to said first heating element from said electrical source.

5. The vaporizer of claim 4 wherein said sensor is a temperature sensor.

6. The vaporizer of claim 4 wherein said sensor senses the volume of said substance in said funnel.

7. The vaporizer of claim 1 wherein said mouthpiece further comprises a loading chamber positioned above said funnel so as to direct a substance placed in said loading chamber into said funnel.

8. The vaporizer of claim 7 wherein said loading chamber comprises a second heating element electrically connected to said electrical source.

9. The vaporizer of claim 8, wherein electrical power from said electrical source to said second heating element is initiated by a user pressing a button.

10. The vaporizer of claim 8 further comprising a sensor positioned in said loading chamber and electrically connected to a controller capable of adjusting electrical power provided to said second heating element from said electrical source.

11. The vaporizer of claim 10 wherein said sensor is a temperature sensor.

12. The vaporizer of claim 7 wherein said mouthpiece further comprises a mouthpiece lid, wherein said mouthpiece lid provides access to said loading chamber when in an open position, and seals said loading chamber when in a closed position, and said mouthpiece lid comprises an inhalation opening that provides an air pathway for a user to inhale a substance vaporized by said heat source of said atomizer.

13. The vaporizer of claim 1, wherein said heat source is a heating coil.

14. The vaporizer of claim 1, wherein said heat source is a heated pan.

15. The vaporizer of claim 1, wherein electrical power from said electrical source to said heat source is initiated by a user pressing a button.

16. The vaporizer of claim 1, wherein said mouthpiece further comprises a window that enable a user to view the inside of said mouthpiece.

17. The vaporizer of claim 1, wherein said atomizer is ceramic.

18. The vaporizer of claim 1, wherein an opening of said funnel is between 1 millimeter and 3 millimeters in diameter.

19. A vaporizer mouthpiece comprising:
an atomizer electrically connectable with an electrical source and comprising a heat source;
a funnel positioned directly above said atomizer so as to direct a substance placed in said funnel into say atomizer;
a loading chamber positioned directly above said funnel so as to direct a substance placed in said loading chamber into said funnel; and
a first heating element proximate to said funnel in electrical communication with said electrical source.

20. The vaporizer mouthpiece of claim 19 further comprising a second heating element proximate to said loading chamber in electrical communication with said electrical source.
